(19) United States
(12) Patent Application Publication
(10) Pub. No.: US 2019/0311524 A1
(43) Pub. Date: Oct. 10, 2019

(54) METHOD AND APPARATUS FOR REAL-TIME VIRTUAL VIEWPOINT SYNTHESIS

(71) Applicant: PEKING UNIVERSITY SHENZHEN GRADUATE SCHOOL, Shenzhen (CN)

(72) Inventors: Ronggang WANG, Shenzhen (CN); Jiajia LUO, Shenzhen (CN); Xiubao JIANG, Shenzhen (CN); Wen GAO, Shenzhen (CN)

(21) Appl. No.: 16/314,958

(22) PCT Filed: Jul. 22, 2016
(86) PCT No.: PCT/CN2016/090961

§ 371 Date: Jan. 3, 2019

(51) Int. Cl. G06T 15/20; G06T 19/00; G06T 7/564; G06T 17/00

(52) U.S. Cl. CPC G06T 15/20; G06T 17/00; G06T 7/564; G06T 19/006

(57) ABSTRACT

Embodiments of the present disclosure provide a method and apparatus for real-time virtual viewpoint synthesis; during the whole process of synthesizing virtual viewpoint images, unlike the prior art, the method and apparatus for virtual viewpoint synthesis according to the embodiments above do not rely on depth maps and thus effectively avoid the problems incurred by depth-image-based rendering.

### CROSS-REFERENCE TO RELATED APPLICATIONS

The present application is a national stage filing under 35 U.S.C. § 371 of PCT/CN2016/090961, filed on Jul. 22, 2016 incorporated herein by reference in its entirety.

### FIELD

Embodiments of the present disclosure generally relate to the field of virtual viewpoint synthesis, and more specifically relate to a method and an apparatus for real-time virtual viewpoint synthesis.

### BACKGROUND

Currently, with increasing maturity of 3D-related technologies, it has become a reality to watch 3D TV at home. However, a compulsory requirement of wearing 3D glasses impedes household users from embracing 3D TVs.

A multi-viewpoint 3D display device makes it possible to watch 3D videos with naked eyes. This device needs multi-channel video streams as inputs, and the specific number of channels varies with different devices. A thorny problem for the multi-viewpoint 3D display device is how to generate multi-channel video streams. A simplest approach is to directly shoot corresponding video streams from various viewpoints, which, however, is the most impractical, because for multi-channel video streams, the costs are high for both shooting and transmission; and different devices need a different number of channels of video streams.

In the prior art, S3D (Stereoscopic 3D) is a dominant approach of generating 3D contents, which will be still so in many years to come. A most perfect solution is that a multi-viewpoint 3D display device is equipped with an automatic, real-time conversion system to convert the S3D to a corresponding number of channels of video streams without affecting the established 3D industrial chain. The technology of converting the S3D to multi-channel video streams is referred to as “virtual viewpoint synthesis.”

A typical virtual viewpoint synthesis technology is DIBR (Depth-Image-Based Rendering), a synthesis quality of which relies on the precision of depth images. However, the existing depth estimation algorithms are not mature enough, and high-precision depth images are usually generated by manual interactions in a semi-automated way; besides, due to mutual occlusion of objects in a real scene, holes will be produced in a virtual viewpoint which is synthesized based on depth images.

The above problems all restrict the DIBR from generating contents automatically and in real-time for a multi-viewpoint 3D display device.

### SUMMARY

According to a first aspect of the present disclosure, a method for real-time virtual viewpoint synthesis is provided, comprising:

extracting sparse disparity data based on images of left and right-channel real viewpoints;

computing coordinate mappings W_{L} and W_{R} from pixel coordinates of the left-channel real viewpoint and pixel coordinates of the right-channel real viewpoint to a virtual viewpoint at a central position based on the extracted sparse disparity data, respectively;

interpolating the coordinating mapping W_{L} from the left-channel real viewpoint to the virtual viewpoint at the central position to obtain coordinate mappings W_{L1}˜W_{LN} from the left-channel real viewpoint to virtual viewpoints at a plurality of other positions, where N is a positive integer; and/or, interpolating the coordinating mapping W_{R} from the right-channel real viewpoint to the virtual viewpoint at the central position to obtain coordinate mappings W_{R1}˜W_{RM} from the right-channel real viewpoint to virtual viewpoints at a plurality of other positions, where M is a positive integer;

synthesizing images of the virtual viewpoints at corresponding positions based on the image of the left-channel real viewpoint and the coordinate mappings W_{L1}˜W_{LN} of the virtual points, respectively; and/or, synthesizing images of the virtual viewpoints at corresponding positions based on the image of the right-channel real viewpoint and the coordinate mappings W_{R1}˜W_{RM} of the corresponding virtual points, respectively.

In a preferred embodiment, extracting sparse disparity data based on images of left and right-channel real viewpoints specifically comprises:

performing FAST feature detection to the images of the left and right-channel real viewpoints to obtain a plurality of feature points;

computing feature descriptors of respective feature points using BRIEF; and

computing Hamming distances from the feature descriptors of the respective feature points in the image of the left-channel real viewpoint to the feature descriptors of the respective feature points in the image of the right-channel real viewpoint, respectively, and performing feature point matching based on a minimum Hamming distance.

In a preferred embodiment, extracting the sparse disparity data based on the images of left and right-channel real viewpoints is performed using a GPU; and/or synthesizing the images of virtual viewpoints at the corresponding positions is performed using the GPU.

According to a second aspect of the present disclosure, an apparatus for real-time virtual viewpoint synthesis is provided, comprising:

a disparity extracting unit configured for extracting sparse disparity data based on images of left and right-channel real viewpoints;

a coordinate mapping unit configured for computing coordinate mappings W_{L} and W_{R} from pixel coordinates of the left-channel real viewpoint and pixel coordinates of the right-channel real viewpoint to a virtual viewpoint at a central position based on the extracted sparse disparity data, respectively;

an interpolating unit configured for interpolating the coordinating mapping W_{L} from the left-channel real viewpoint to the virtual viewpoint at the central position to obtain coordinate mappings W_{L1}˜W_{LN} from the left-channel real viewpoint to virtual viewpoints at a plurality of other positions, where N is a positive integer; and/or, interpolating the coordinating mapping W_{R} from the right-channel real viewpoint to the virtual viewpoint at the central position to obtain coordinate mappings W_{R1}˜W_{RM} from the right-channel real viewpoint to virtual viewpoints at a plurality of other positions, where M is a positive integer;

a synthesizing unit configured for synthesizing images of the virtual viewpoints at corresponding positions based on the image of the left-channel real viewpoint and the coordinate mappings W_{L1}˜W_{LN} of the corresponding virtual points, respectively; and/or, synthesizing images of the virtual viewpoints at corresponding positions based on the image of the right-channel real viewpoint and the coordinate mappings W_{R1}˜W_{RM} of the virtual points, respectively.

In a preferred embodiment, the disparity extracting unit comprises:

a FAST feature detecting unit configured for performing FAST feature detection to the images of the left and right-channel real viewpoints to obtain a plurality of feature points;

a BRIEF feature descriptor unit configured for computing feature descriptors of respective feature points using BRIEF; and

a feature point matching unit configured for computing Hamming distances from the feature descriptors of the respective feature points in the image of the left-channel real viewpoint to the feature descriptors of the respective feature points in the image of the right-channel real viewpoint, respectively, and performing feature point matching based on a minimum Hamming distance.

In a preferred embodiment, the disparity extracting unit performs extracting of the sparse disparity data based on GPU parallel computing; and/or the synthesizing unit performs synthesizing of the images of the virtue viewpoints based on GPU parallel computing.

During the whole process of synthesizing virtual viewpoint images, unlike the prior art, the method and apparatus for virtual viewpoint synthesis according to the embodiments above do not rely on depth maps and thus effectively avoid the problems incurred by depth-image-based rendering (DIBR):

When extracting the sparse disparity data, the method and apparatus for real-time virtual viewpoint synthesis according to the embodiments above compute the feature descriptors of respective feature points using the FAST feature detection and BRIEF, which not only ensures a matching precision, but also achieves a very fast computation speed, thereby facilitating real-time implementation of virtual viewpoint synthesis; and

By leveraging a GPU's parallel computing capability, the method and apparatus for real-time virtual viewpoint synthesis according to the embodiments above extract the sparse disparity data based on the images of left and right-channel real viewpoints using the GPU, and/or synthesize the images of the virtual viewpoints at corresponding positions using the GPU, which accelerates the computation speed and facilitates real-time implementation of virtual viewpoint synthesis.

### BRIEF DESCRIPTION OF THE DRAWINGS

FIG. 1 is a flow diagram of a method for real-time virtual viewpoint synthesis according to an embodiment of the present disclosure;

FIG. 2 is a flow diagram of extracting sparse disparity data in the method for real-time virtual viewpoint synthesis according to an embodiment of the present disclosure;

FIG. 3 is a thread assignment diagram of performing, in a GPU, FAST feature detection in the method for real-time virtual viewpoint synthesis according to an embodiment of the present disclosure;

FIG. 4 is a thread assignment diagram of computing, in the GPU, Hamming distances in the method for real-time virtual viewpoint synthesis according to an embodiment of the present disclosure;

FIG. 5 is a thread assignment diagram of performing, in the GPU, cross validation in the method for real-time virtual viewpoint synthesis according to an embodiment of the present disclosure;

FIG. 6 is a schematic diagram of positional relationships between 8 viewpoints (including 2 real viewpoints and 6 virtual viewpoints) in the method for real-time virtual viewpoint synthesis according to an embodiment of the present disclosure, where the distances shown in the figure are normalized distances between adjacent two channels of real viewpoints;

FIG. 7 is a thread assignment diagram when synthesizing, in the GPU, virtual viewpoints at corresponding positions based on the left/right views and the warps at the corresponding positions in the method for real-time virtual viewpoint synthesis according to an embodiment of the present disclosure;

FIG. 8 is an effect schematic diagram of the method for real-time virtual viewpoint synthesis according to an embodiment of the present disclosure, wherein FIGS. 8(a)˜(h) correspond to the views of respective viewpoints in FIG. 6:

FIG. 9 is a structural schematic diagram of an apparatus for real-time virtual viewpoint synthesis according to an embodiment of the present disclosure:

FIG. 10 is a structural schematic diagram of a disparity extracting unit in the apparatus for real-time virtual viewpoint synthesis according to an embodiment of the present disclosure;

FIG. 11 is a structural schematic diagram of a FAST feature detection unit in the apparatus for real-time virtual viewpoint synthesis according to an embodiment of the present disclosure.

### DETAILED DESCRIPTION OF EMBODIMENTS

The present disclosure discloses a method and apparatus for real-time virtual viewpoint synthesis; during the whole process of synthesizing virtual viewpoint images, unlike the prior art, the present disclosure needs not rely on a depth map and thus effectively avoids the problems incurred by the depth-image-based rendering; for example, it does not need to rely on dense depth maps and thus will not cause holes; besides, the present disclosure also leverages the strong parallel computing capability of a GPGPU (general-purpose computing on graphics processing units) to accelerate the IDW algorithm, which achieves real-time virtual viewpoint synthesis. The method for real-time virtual viewpoint synthesis according to the present disclosure comprises four major steps:

Firstly, extracting sparse disparity data based on input images of left and right-channel real viewpoints. The sparse disparity is estimated by matching local features of the images. Precision of feature matching is critical to the quality of subsequent synthesis. Considering that the input two channels of views have the same resolution and similar angles, feature operators as needed are not required to be scale/rotation invariant. Therefore, the present disclosure extracts a sparse local feature using a corner detection operator FAST (Features from Accelerated Segment Test) and a binary description operator BRIEF (Binary Robust Independent Elementary Features); although the operators are not scale/rotation invariant, they have a very fast computation speed, and likewise have a very high matching precision. Besides, the parallel computing capability of a GPU is leveraged to accelerate the FAST+BRIEF.

Secondly, computing warps to guide synthesizing of virtual viewpoints. A warp refers to a pixel mapping from image coordinates of a real viewpoint to image coordinates of a virtual viewpoint. To this end, an energy function is first constructed, the energy function being a weighted sum of 3 bound terms, which are a sparse disparity term, a space-domain smoothing term, and a time-domain smoothing term, respectively. Then, the image is divided into triangular meshes, where image coordinates of mesh apexes and pixel points inside a mesh jointly constitute a warp. The coordinates of the mesh apexes are variable terms in the energy function. By minimizing the energy function, say, solving the partial derivative of the energy function and letting the partial derivative expression be 0, these coordinates may be derived. The coordinates of the pixel points inside the mesh may be derived from the triangular mesh apexes through affine transformation. The minimum energy may be solved using an SOR iterative method, and respective warps are solved in parallel by a multi-core CPU using an OpenMP parallel library. Two warps may be derived in this step, i.e., coordinate mappings W_{L} and W_{R} from pixel coordinates of the left-channel real viewpoint and pixel coordinates of the right-channel real viewpoint to a virtual viewpoint at a central position, respectively; this mapping reflects correct changes of disparity.

Then, to adapt the multi-channel viewpoint inputs needed by the multi-viewpoint 3D display device, a corresponding number of warps may be derived by interpolating the W_{L} and W_{R} through interpolation and extrapolation.

Finally, under the guidance of warps, corresponding virtual viewpoints are synthesized. As mentioned above, the warp as computed only includes the coordinate information of the triangular mesh apexes, while the pixels inside the triangle may be solved through affine transformation. Therefore, when synthesizing a corresponding virtual viewpoint, the affine transformation coefficient of each triangular mesh is first solved, and then inverse mapping is performed to render, in the virtual viewpoint, the pixels at corresponding positions in the real viewpoint through bilinear interpolation. Each triangular mesh is independent; therefore, parallel operations may be performed to each triangle by leveraging the parallel computing capability of the GPU.

Hereinafter, the present disclosure will be described in further detail through preferred embodiments with reference to the accompanying drawings.

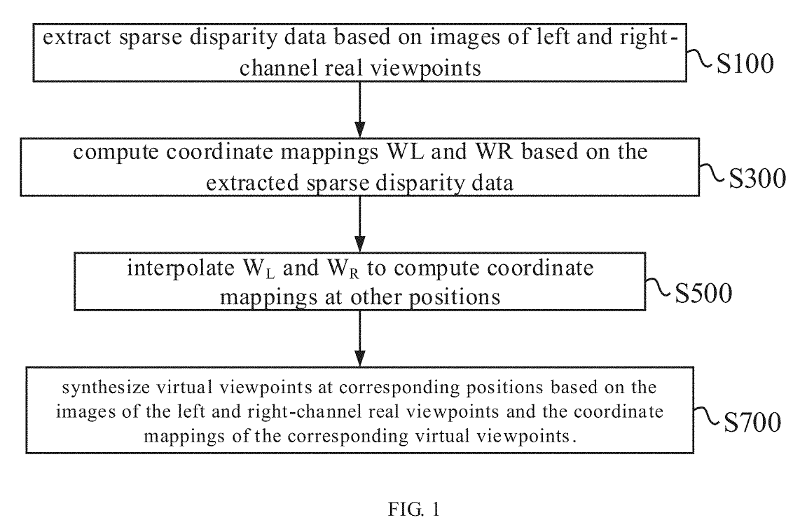

Please refer to FIG. 1, the method for real-time virtual viewpoint synthesis according to the present disclosure comprises steps S100˜S700. In one embodiment, steps S100) and S700 are performed in a GPU, and steps S300 and S500 are performed in a CPU. Detailed explanations thereof are provided below:

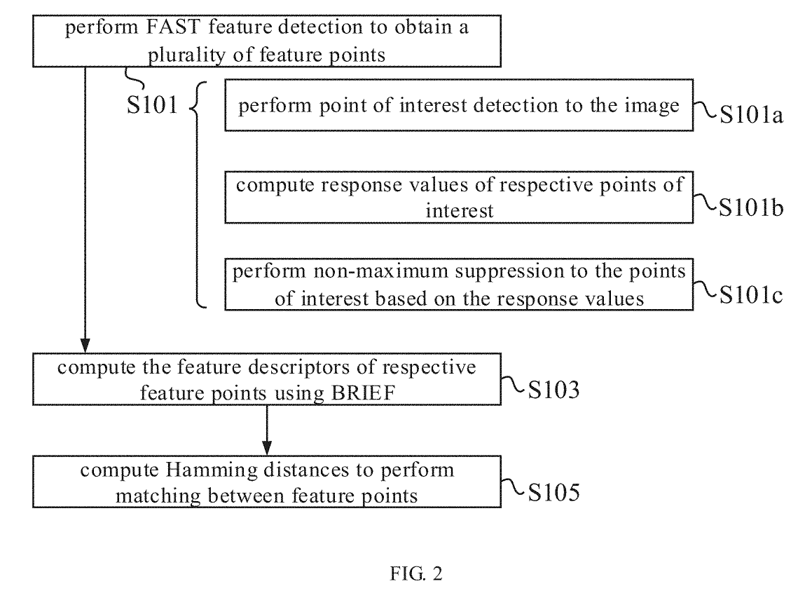

Step S100: extracting sparse disparity data based on images of left and right-channel real viewpoints. In a specific embodiment, as shown in FIG. 2, the step S100 specifically comprises steps S101˜S105.

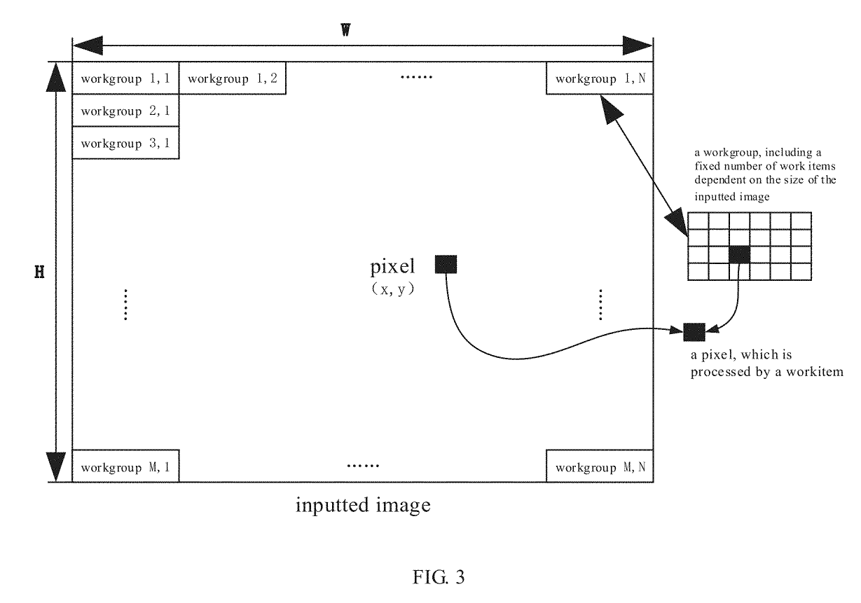

Step S101: performing FAST feature detection to the images of the left and right-channel real viewpoints to obtain a plurality of feature points. In a specific embodiment, the step of performing FAST feature detection to the images of the left and right-channel real viewpoints to obtain a plurality of feature points specifically comprises sub-steps S101a, S101b, and S101c: sub-step S101a: performing point of interest detection to the image; sub-step S101b: computing response values of respective points of interest; sub-step S101c: performing non-maximum suppression to the points of interest based on the response values. For example, after inputting the images of the two-channel real viewpoints, they are processed into grey-scale maps, respectively, and then each image is subjected to the point-of-interest detection. The Inventors realized FAST-12 using OpenCL, and the threshold thresh at the FAST-stage testing was set to 30. As mentioned above, the FAST feature detection comprises three sub-steps; therefore, the Inventor devised three OpenCL kernel functions: firstly, detecting the points of interest; secondly, computing response values of the points of interest; and finally, performing non-maximum suppression to the points of interest based on the response values. The latter two sub-steps mainly function to avoid crowding of a plurality of feature points. In one embodiment, the whole flow is implemented on the GPU, and the three kernel functions are enabled in succession. After the points of interest of the two images are detected, the process is completed. The OpenCL thread assignment policy of this process is illustrated in FIG. 3, where one thread is assigned to each pixel of the image k, and each thread executes a same kernel function, thereby implementing an SIMD (Single Instruction, Multiple Data) parallelism.

Step S103: computing feature descriptors of respective feature points using BRIEF. In a specific embodiment, for example, the step S103 uses the feature points detected in step S101 as inputs, and this process will compute the feature descriptors using BRIEF; preferably, it is also implemented on the GPU. Firstly, the Inventors computed an integral image for the images of left and right-channel viewpoints, the integral image being for quickly smoothing the images to denoise, and then transmitted the computed integral image to the GPU. Please note that the results of detecting the feature points in the step S101 still reside in the GPU memory. The Inventors realized BRIEF32 with the OpenCL, i.e., a 256-bit binary descriptor. In a 48×48 square area centered about a feature point, 256 pairs of sampling points are selected; the sampling points are denoised by querying the integral image with a smoothing kernel with a size of 9. By comparing the gray values of each pair of sampling points, bit 0 or 1 is obtained; after 256 times of comparison, the descriptor of the feature point is obtained. This process devises one OpenCL kernel function, and the thread assignment policy is still shown in FIG. 3, where one thread computes one pixel, and only when the current pixel is a feature point detected in step S101, will the current thread compute a valid descriptor therefor.

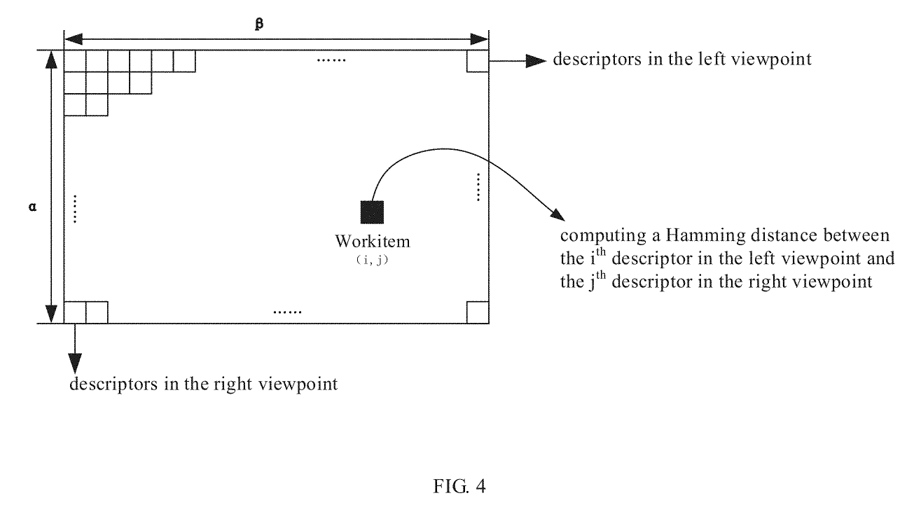

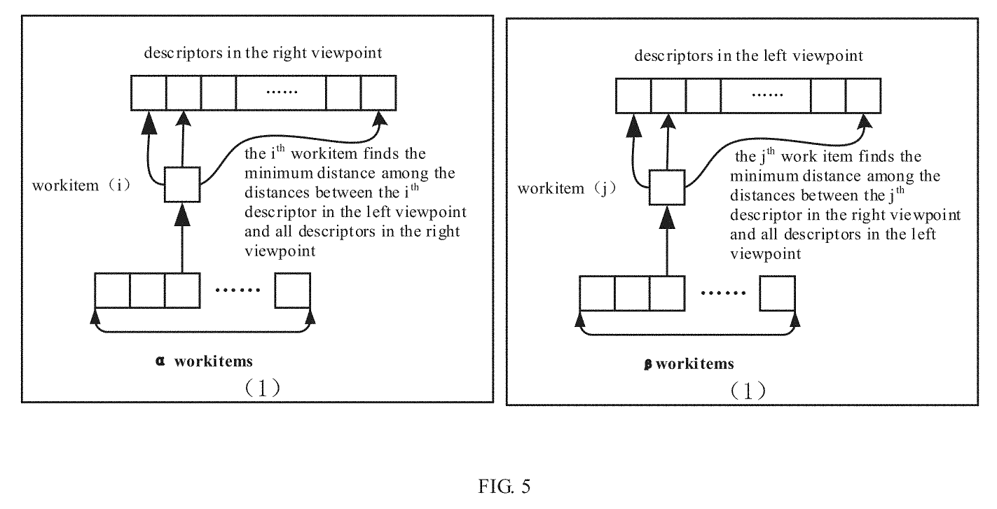

Step S105: computing Hamming distances from the feature descriptors of the respective feature points in the image of the left-channel real viewpoint to the feature descriptors of the respective feature points in the image of the right-channel real viewpoint, respectively, and performing feature point matching based on a minimum Hamming distance. In a specific embodiment, for example, in the step S105, a most matching feature pair is searched by solving the minimum Hamming distance based on the feature descriptors computed in the step S103. Because the results of step S103 are descriptors scattered on the images while the GPU parallel computing favors a continuous data region, the Inventors performed a pre-processing operation. The scattered descriptors were copied one by one to another block of continuous but smaller GPU memory, then the number of descriptors was counted, and their corresponding pixel coordinates were collected. The Inventors performed operations on the two images, respectively, after the pre-processing was completed, the Inventor knew the respective numbers of descriptors of the left and right views, denoted as α and β, respectively. Then, a corresponding number of threads were assigned to parallel solve the Hamming distances from the feature descriptors of respective feature points in the left view to the feature descriptors of respective feature points in the right view, the thread assignment policy being shown in FIG. 4. A Hamming distance between two bit-strings is computed, which may be quickly solved by counting the number of bit “1” in the XOR operation results. The GPU also has a corresponding instruction “popcnt” to support this operation. After the operation is completed, a two-dimensional table may be obtained, including Hamming distances between corresponding descriptors in the left and right views. In the final feature matching stage, a most similar feature pair may be searched by table look-up. To ensure matching precision, in one embodiment, cross validation may be performed, as shown in FIG. 5: firstly, assigning α threads to search a nearest descriptor in the right view for each descriptor in the left view, and then assigning β threads to search a nearest descriptor in the left view for each descriptor in the right view. The cross validation ensures that the two feature points are best matching to each other. The image coordinates of the matched feature points are outputted as the inputs for the step S300.

Step S300: computing coordinate mappings W_{L} and W_{R} from pixel coordinates of the left-channel real viewpoint and pixel coordinates of the right-channel real viewpoint to a virtual viewpoint at a central position based on the extracted sparse disparity data, respectively; these mappings reflect correct changes of disparity. In a specific embodiment, the step S300 may comprise two steps: constructing an energy function and solving a linear equation, which will be detailed infra.

(1) a process of constructing an energy function is detailed below with the W_{L} of the left-channel real viewpoint as an example.

The energy function may comprise a sparse disparity term, a space-domain smoothing term, and a time-domain smoothing term, represented by the following expression:

E(w_{L})=λ_{d}E_{d}(w_{L})+λₛEₛ(w_{L})+λₜEₜ(w_{L});

Hereinafter, the sparse disparity term, the space-domain smoothing term, and the time-domain smoothing term in the energy function will be explained below, respectively.

A. Sparse Disparity Term

With the local feature point pair (p_{L}, p_{R}) of the image as an input, a triangle s including the feature point p_{L} is first located; let the apexes of the triangle be [v₁,v₂,v₃] and the center-of-mass coordinates about s be [α,βγ], the following relation is satisfied:

p_{L}=αv₁+βv₂+γv₃;

where p_{M} is a projection position of the feature point p_{L} in W_{L}, and the sparse disparity term is for binding the distance between p_{M} and p_{L}; then the following relation expression is derived:

E₁(p_{L})=∥αw_{L}(v₁)+βw_{L}(v₂)+γw_{L}(v₃)−p_{M∥}²;

where p_{M}=(p_{L}+p_{R})/2; by traversing respective feature point pairs and adding up the corresponding E₁(p_{L}), the sparse disparity term is derived below:

$${E}_{d} ( {w}_{L} ) = {\sum }_{{P}_{L} ∈ F}^{ } {E}_{1} ( {p}_{L} ) ;$$

b. Space-Domain Smoothing Term

where (m, n) is an index number of a triangular mesh and p (m, n) corresponds to the image coordinates of a triangular apex. The following two functions are defined below, for measuring morphing of the vertical edge and the horizontal edge of the triangle:

hor_dist(x,y)=∥w_{L}(p(x+1,y))−w_{L}(p(x,y))−(p(x+1,y)−p(x,y))∥²;

ver_dist(x,y)=∥w_{L}(p(x,y+1))−w_{L}(p(x,y))−(p(x,y+1)−p(x,y))∥²;

The apex of the upward-pointing right triangle Sᵤₚₚₑᵣ is [p(m,n), p(m+1,n), p(m,n+1)], while the apex of the downward-pointing right angle S_{lower} is [p(m+1,n), p(m+1,n+1), p(m,n+1)]; the space-domain smoothing term binds the geometrical morphing of these triangles:

E₂(m,n)=Eᵤₚₚₑᵣ(m,n)+E_{lower}(m,n);

Eᵤₚₚₑᵣ(m,n)=ver_dist(m,n)+hor_dist(m,n);

E_{lower}(m,n)=ver_dist(m+1,n)+hor_dist(m,n+1)

By traversing all meshes and adding up the corresponding E₂ (m, n), the space-domain smoothing term is shown below:

$${E}_{s} ( m , n ) = {\sum }_{( m , n )}^{ } {E}_{2} ( m , n ) ;$$

c. Time-Domain Smoothing Term

The time-domain smoothing term is for ensuring image texture stability in the time domain. Let w_{L}^{j} represent the warp of the j^{th} frame, then the time-domain smoothing term may be constructed below:

$${E}_{t} ( {w}_{L}^{j} ) = {\sum }_{( m , n )}^{ } {‖ {w}_{L}^{j} ( p ( m , n ) ) - {w}_{L}^{j - 1} ( p ( m , n ) ) ‖}^{2} ;$$

(2) Solving a Linear Equation

The energy function constructed above is a quadratic expression, where the apexes of a triangular mesh in the warp are taken as variables. When searching a minimum energy value, partial derivatives of the transverse and vertical axes of the apexes may be solved based on the energy function, respectively. A linear expression Ax=b may be derived and expressed into the following matrix form:

$$[ \begin{matrix}{a}_{11} … {a}_{1 N} \\ ⋮ \\ {a}_{N 1} … {a}_{NN}\end{matrix} ] \times [ \begin{matrix}{x}_{1} \\ ⋮ \\ {x}_{N}\end{matrix} ] = [ \begin{matrix}{b}_{1} \\ ⋮ \\ {b}_{N}\end{matrix} ] ;$$

The size of solution space [x₁ . . . x_{N}]^{T} is dependent on the number of triangular meshes. In an example, the image is divided into 64×48 meshes. It may be seen that the coefficient matrix is a 3185×3185 square matrix, also a sparse band matrix and a strict diagonally dominant matrix. Therefore, in one embodiment, an approximate solution may be solved by an SOR iterative method, rather than a matrix factorization method. For a video, the solution of the immediately preceding frame is used as an initial value for the current frame to perform SOR iteration so as to sufficiently utilize the time-domain correlation.

Please note that by solving the partial derivatives of the transverse and longitudinal coordinates of an apex, two linear expressions may be derived; in addition, a warp is also needed to be computed for the right view, such that 4 linear equations need to be solved in total. To this end, in an embodiment, an OpenMP library may be used for parallel solving with a multi-core CPU.

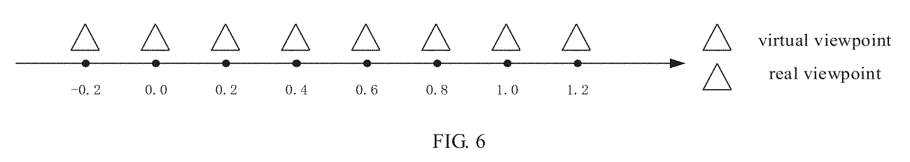

Step 500: interpolating the coordinating mapping W_{L} from the left-channel real viewpoint to the virtual viewpoint at the central position to obtain coordinate mappings W_{L1}˜W_{LN} from the left-channel real viewpoint to virtual viewpoints at a plurality of other positions, where N is a positive integer; and/or, interpolating the coordinating mapping W_{R} from the right-channel real viewpoint to the virtual viewpoint at the central position to obtain coordinate mappings W_{R1}˜W_{RM} from the right-channel real viewpoint to virtual viewpoints at a plurality of other positions, where M is a positive integer. Please refer to FIG. 6, which takes 8 channels of viewpoints as an example. To obtain 8 channels of viewpoints, the warps at corresponding positions may be derived by interpolation. α Represents a position (normalized coordinates) of the virtual viewpoint, and u represents a warp at the real viewpoint, i.e., a standard mesh partition. Then, the warps at the three virtual viewpoints −0.2, 0.2, and 0.4 may be obtained by interpolation through the equation W_{L}^{α}=2α(W_{L}^{0.5}−u)+u, and the warps at the three viewpoint positions 0.6, 0.8, and 1.2 may be obtained by interpolation through the equation W_{R}^{α}=2(1−α)(W_{R}^{0.5}−u)+u. In a preferred embodiment, based on the coordinating mapping W_{L} from the left-channel real viewpoint to the virtual viewpoint at the central position, coordinate mappings W_{L1}˜W_{LN} from the left-channel real viewpoint to virtual viewpoints at a plurality of other positions are obtained by interpolation, where N is a positive integer; and/or, based on the coordinating mapping W_{R} from the right-channel real viewpoint to the virtual viewpoint at the central position, coordinate mappings W_{R1}˜W_{RM} from the right-channel real viewpoint to virtual viewpoints at a plurality of other positions are obtained by interpolation. In a preferred embodiment, N is equal to M, and the resultant positions of the virtual viewpoints are symmetrical about the central position.

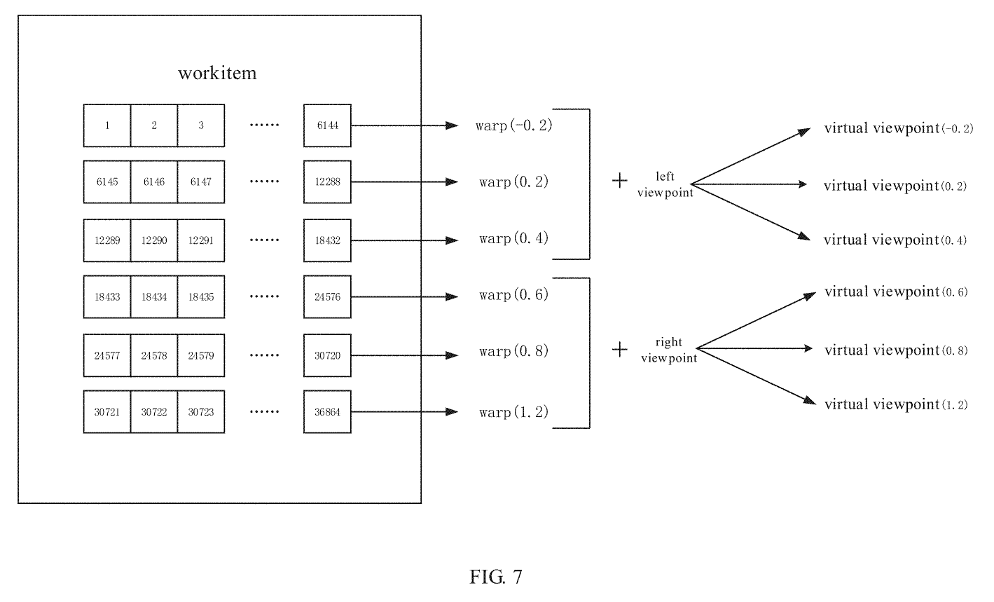

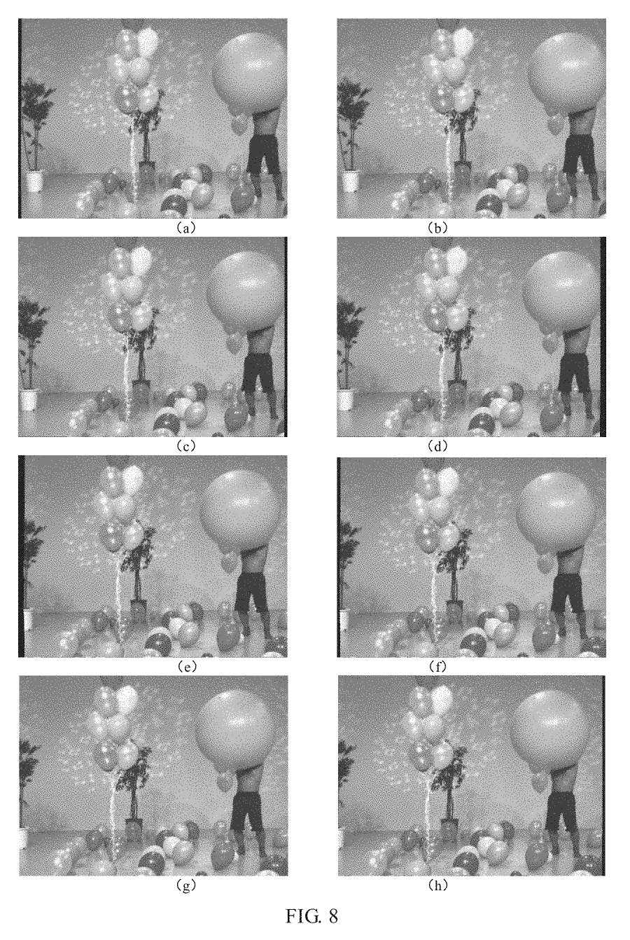

Step S700: synthesizing images of the virtual viewpoints at corresponding positions based on the image of the left-channel real viewpoint and the coordinate mappings W_{L1}˜W_{LN} of the corresponding virtual points, respectively; and/or, synthesizing images of the virtual viewpoints at corresponding positions based on the image of the right-channel real viewpoint and the coordinate mappings W_{R1}˜W_{RM} of the corresponding virtual points, respectively. In a preferred embodiment, the images of the virtual viewpoints at the corresponding positions are synthesized based on the image of the left-channel real viewpoint and coordinate mappings W_{L1}˜W_{LN}, respectively, wherein the coordinate mappings WL1˜WLN are coordinate mappings from the left-channel real viewpoint to the virtual viewpoints at a plurality of positions to the left of the central position; and the images of the virtual viewpoints at the corresponding positions are synthesized based on the image of the right-channel real viewpoint and the coordinate mappings W_{R1}˜W_{RM}, respectively, wherein the coordinate mappings W_{R1}˜W_{RM} are coordinate mappings from the right-channel real viewpoint to the virtual viewpoints at a plurality of positions to the right of the central position. Now, the explanation will be made still with the example of FIG. 6. The mappings of the input left and right views at the virtual viewpoint positions −0.2, 0.2, 0.4, 0.6, 0.8 and 1.2 (i.e., morphing W−0.2, W0.2, W0.4, W0.6, W0.8, W1.2) have been obtained in the step S500. To synthesize the virtual views, the virtual views at the positions −0.2, 0.2, and 0.4 are synthesized based on the input left view L_{L} and W−0.2, W0.2, and W0.4, and the virtual views at the positions 0.6, 0.8, and 1.2 are synthesized based on the input right view I_{R} and W0.6, W0.8, and W1.2. Specifically, image domain morphing may be performed to respective triangular meshes to thereby synthesize virtual views. A triangular mesh has three apex identifications, while the meshes inside the triangle are solved through affine transformation. To synthesize a target image, an affine transformation coefficient is first solved, and then reverse mapping is performed; through bilinear interpolation, the pixels at the corresponding positions in the real viewpoints are mapped to the virtual viewpoints. Continued with the example above, the input view is divided into 64×48 meshes; to synthesize 6 channels of virtual viewpoints, 64×48×2×6 triangles need to be computed in total. This step also needs a high parallelism; therefore, an OpenCL kernel function may be devised for parallel computing. The corresponding linear assignment policy is shown in FIG. 7. The resultant 6 warps and the left and right-channel real viewpoints may be inputted into the GPU memory; in the kernel function, the virtual viewpoint corresponding to the triangle processed by the current thread is first determined in the kernel function, the affine transformation coefficient is solved, and then the pixels in the virtual viewpoints are rendered according to the real views. After the work in all of the 36864 threads is completed, the 6 channels of virtual views are synthesized. The synthesized 6 channels of virtual views plus the input 2 channels of real views correspond to 8 channels of viewpoints. By far, the steps of the real-time virtual viewpoint synthesis technology are all performed. In one embodiment, the three parameters {λ_{d},λₛ,λₜ} of the energy function may be set to {1, 0.05, 1}. Experiment shows that for a 720P video, the present disclosure may convert the S3D in real-time to 8 channels of viewpoints; the effect is shown in FIG. 8, where FIGS. 8(a)˜8(h) correspond to the views of respective viewpoints in FIG. 6, FIG. (8a) is a virtual view at the position −0.2, FIG. 8(b) is a real view at the position 0 (i.e., the image of the input left-channel real viewpoint), FIG. 8(c) is a virtual view at the position 0.2, FIG. 8(d) is a virtual view at the position 0.4, FIG. 8(e) is a virtual view at the position 0.6, FIG. 8(f) is the virtual view at the position 0.8, FIG. 8(g) is the real view at position 1 (i.e., the inputted image of the right-channel real viewpoint), and FIG. 8(h) is the virtual view at the position 1.2.

During the whole process of synthesizing a virtual viewpoint image, unlike the prior art, the method for virtual viewpoint synthesis according to the present disclosure does not rely on depth maps and thus effectively avoids the problems incurred by depth-image-based rendering (DIBR); when extracting the sparse disparity data, the method for real-time virtual viewpoint synthesis according to the present disclosure computes the feature descriptors of respective feature points using the FAST feature detection and BRIEF, which not only ensures a matching precision, but also achieves a very fast computation speed, thereby facilitating real-time implementation of virtual viewpoint synthesis; and by leveraging a GPU's parallel computing capability, the method for real-time virtual viewpoint synthesis according to the present disclosure extracts the sparse disparity data based on the images of left and right-channel real viewpoints using the GPU, and/or synthesizes the images of the virtual viewpoints at corresponding positions using the GPU, which accelerates the computation speed and facilitates real-time implementation of virtual viewpoint synthesis.

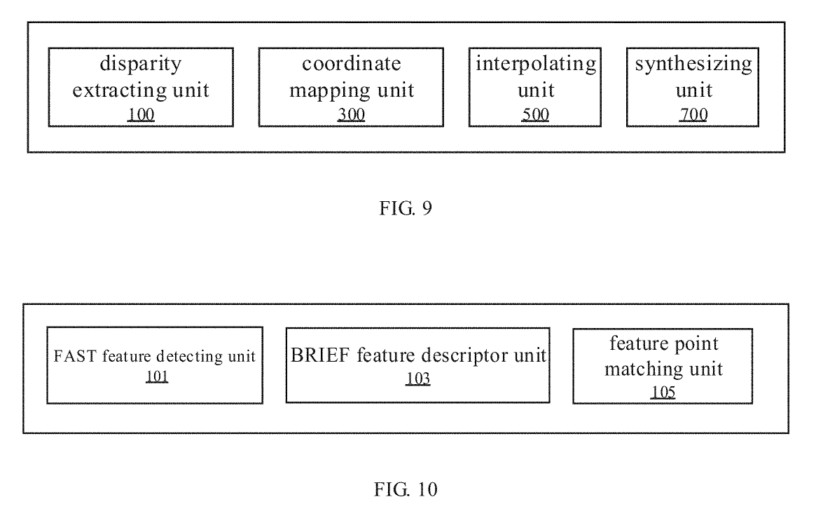

Correspondingly, the present disclosure discloses an apparatus for real-time virtual viewpoint synthesis, as shown in FIG. 9, comprising: a disparity extracting unit 100, a coordinate mapping unit 300, an interpolating unit 500, and a synthesizing unit 700, which will be detailed infra.

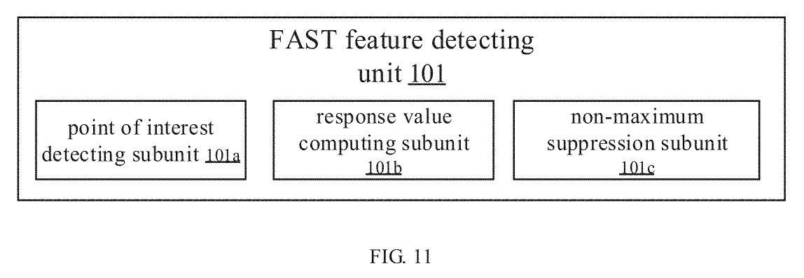

The disparity extracting unit 100 is configured for extracting sparse disparity data based on images of left and right-channel real viewpoints. In one embodiment, as shown in FIG. 10, the disparity extracting unit 100 comprises a FAST feature detecting unit 101, a BRIEF feature descriptor unit 103, and a feature point matching unit 105, wherein the FAST feature detecting unit 101 is configured for performing FAST feature detection to the images of the left and right-channel real viewpoints to obtain a plurality of feature points; the BRIEF feature descriptor unit 103 is configured for computing feature descriptors of respective feature points using BRIEF; and the feature point matching unit 105 is configured for computing Hamming distances from the feature descriptors of respective feature points in the image of the left-channel real viewpoint to the feature descriptors of respective feature points in the image of the right-channel real viewpoint, and performing feature point matching based on a minimum Hamming distance. In one embodiment, please refer to FIG. 11, the FAST feature detecting unit 101 comprises a point of interest detecting sub-unit 101a, a response value computing sub-unit 101b, and a non-maximum suppression unit 101c, wherein the point of interest detecting sub-unit 101a is configured for performing point of interest detection to the image; the response value computing sub-unit 101b is configured for computing response values of respective points of interest; and the non-maximum suppression sub-unit 101c is configured for performing non-maximum suppression to the points of interest based on the response values.

The coordinate mapping unit 300 is configured for computing coordinate mappings W_{L} and W_{R} from pixel coordinates of the left-channel real viewpoint and pixel coordinates of the right-channel real viewpoint to a virtual viewpoint at a central position based on the extracted sparse disparity data, respectively; this mapping reflects correct changes of disparity.

The interpolating unit 500 is configured for interpolating the coordinating mapping W_{L} from the left-channel real viewpoint to the virtual viewpoint at the central position to obtain coordinate mappings W_{L1}˜W_{LN} from the left-channel real viewpoint to virtual viewpoints at a plurality of other positions, where N is a positive integer; and/or, interpolating the coordinating mapping W_{R} from the right-channel real viewpoint to the virtual viewpoint at the central position to obtain coordinate mappings W_{R1}˜W_{RM} from the right-channel real viewpoint to virtual viewpoints at a plurality of other positions, where M is a positive integer. In a preferred embodiment, the interpolating unit 500 performs interpolation to obtain coordinate mappings W_{L1}˜W_{LN} from the left-channel real viewpoint to virtual viewpoints at a plurality of other positions based on the coordinating mapping W_{L} from the left-channel real viewpoint to the virtual viewpoint at the central position, where N is a positive integer; and/or, the interpolating unit 500 performs interpolation to coordinate mappings W_{R1}˜W_{RM} from the right-channel real viewpoint to virtual viewpoints at a plurality of other positions based on the coordinating mapping W_{R} from the right-channel real viewpoint to the virtual viewpoint at the central position. In a preferred embodiment, N is equal to M. and the resultant positions of the virtual viewpoints are symmetrical about the central position.

The synthesizing unit 700 is configured for synthesizing images of the virtual viewpoints at corresponding positions based on the image of the left-channel real viewpoint and the coordinate mappings W_{L1}˜W_{LN} of the corresponding virtual points, respectively; and/or, synthesizing images of the virtual viewpoints at corresponding positions based on the image of the right-channel real viewpoint and the coordinate mappings W_{R1}˜W_{RM} of the corresponding virtual points, respectively. In a preferred embodiment, the synthesizing unit 700 synthesizes images of the virtual viewpoints at the corresponding positions based on the image of the left-channel real viewpoint and coordinate mappings W_{L1}˜W_{LN}, respectively, wherein the coordinate mappings W_{L1}˜W_{LN} are coordinate mappings from the left-channel real viewpoints to the virtual viewpoints at a plurality of positions to the left of the central position; and the synthesizing unit 700 synthesizes images of the virtual viewpoints at the corresponding positions based on the image of the right-channel real viewpoint and the coordinate mappings W_{R1}˜W_{RM}, respectively, wherein the coordinate mappings W_{R1}˜W_{RM} are coordinate mappings from the right-channel real viewpoints to the virtual viewpoints at a plurality of positions to the right of the central position.

In a preferred embodiment, in the apparatus for real-time virtual viewpoint synthesis of the present disclosure, the disparity extracting unit 100 performs extracting of the sparse disparity data based on GPU parallel computing; and the synthesizing unit 700 performs synthesizing of the images of the virtue viewpoints based on GPU parallel computing.

The specific embodiments have been applied above to illustrate the present disclosure, which are just for helping understand the present disclosure, rather than limiting the present disclosure. For a person of normal skill in the art, the specific embodiments may be varied without departing from the idea of the present disclosure.

1. A method for real-time virtual viewpoint synthesis, comprising:
extracting sparse disparity data based on images of left and right-channel real viewpoints;
computing coordinate mappings W_{L} and W_{R} from pixel coordinates of the left-channel real viewpoint and pixel coordinates of the right-channel real viewpoint to a virtual viewpoint at a central position based on the extracted sparse disparity data, respectively;
interpolating the coordinating mapping W_{L} from the left-channel real viewpoint to the virtual viewpoint at the central position to obtain coordinate mappings W_{L1}˜W_{LN} from the left-channel real viewpoint to virtual viewpoints at a plurality of other positions, where N is a positive integer; and/or, interpolating the coordinating mapping WR from the right-channel real viewpoint to the virtual viewpoint at the central position to obtain coordinate mappings W_{R1}˜W_{RM} from the right-channel real viewpoint to virtual viewpoints at a plurality of other positions, where M is a positive integer; and
synthesizing images of the virtual viewpoints at corresponding positions based on the image of the left-channel real viewpoint and the coordinate mappings W_{L1}˜W_{LN} of the corresponding virtual points, respectively; and/or, synthesizing images of the virtual viewpoints at corresponding positions based on the image of the right-channel real viewpoint and the coordinate mappings W_{R1}˜W_{RM} of the corresponding virtual points, respectively.

2. The method for real-time virtual viewpoint synthesis according to claim 1, wherein extracting sparse disparity data based on images of left and right-channel real viewpoints comprises:
performing FAST feature detection to the images of the left and right-channel real viewpoints to obtain a plurality of feature points;
computing feature descriptors of respective feature points using BRIEF; and
computing Hamming distances from the feature descriptors of the respective feature points in the image of the left-channel real viewpoint to the feature descriptors of the respective feature points in the image of the right-channel real viewpoint, respectively, and performing feature point matching based on a minimum Hamming distance.

3. The method for real-time virtual viewpoint synthesis according to claim 2, wherein performing FAST feature detection to the images of the left and right-channel real viewpoints to obtain a plurality of feature points specifically comprises:
performing point of interest detection to the image;
computing response values of respective points of interest; and
performing non-maximum suppression to the points of interest based on the response values.

4. The method for real-time virtual viewpoint synthesis according to claim 1, wherein extracting the sparse disparity data based on the images of left and right-channel real viewpoints are performed using a GPU; and/or synthesizing the image of virtual viewpoints at the corresponding positions is performed using the GPU.

5. An apparatus for real-time virtual viewpoint synthesis, comprising:
a disparity extracting unit configured for extracting sparse disparity data based on images of left and right-channel real viewpoints;
a coordinate mapping unit configured for computing coordinate mappings W_{L} and W_{R} from pixel coordinates of the left-channel real viewpoint and pixel coordinates of the right-channel real viewpoint to a virtual viewpoint at a central position based on the extracted sparse disparity data, respectively;
an interpolating unit configured for interpolating the coordinating mapping W_{L} from the left-channel real viewpoint to the virtual viewpoint at the central position to obtain coordinate mappings W_{L1}˜W_{LN} from the left-channel real viewpoint to virtual viewpoints at a plurality of other positions, where N is a positive integer; and/or, interpolating the coordinating mapping W_{R} from the right-channel real viewpoint to the virtual viewpoint at the central position to obtain coordinate mappings W_{R1}˜W_{RM} from the right-channel real viewpoint to virtual viewpoints at a plurality of other positions, where M is a positive integer; and
a synthesizing unit configured for synthesizing images of the virtual viewpoints at corresponding positions based on the image of the left-channel real viewpoint and the coordinate mappings W_{L1}˜W_{LN} of the corresponding virtual points, respectively; and/or, synthesizing images of the virtual viewpoints at corresponding positions based on the image of the right-channel real viewpoint and the coordinate mappings W_{R1}˜W_{RM} of the corresponding virtual points, respectively.

6. The apparatus for real-time virtual viewpoint synthesis according to claim 5, wherein the disparity extracting unit comprises:
a FAST feature detecting unit configured for performing FAST feature detection to the images of the left and right-channel real viewpoints to obtain a plurality of feature points;
a BRIEF feature descriptor unit configured for computing feature descriptors of respective feature points using BRIEF; and
a feature point matching unit configured for computing Hamming distances from the feature descriptors of the respective feature points in the image of the left-channel real viewpoint to the feature descriptors of the respective feature points in the image of the right-channel real viewpoint, respectively, and performing feature point matching based on a minimum Hamming distance.

7. The apparatus for real-time virtual viewpoint synthesis according to claim 6, wherein the FAST feature detecting unit comprises:
a point of interest detecting subunit configured for performing point of interest detection to the image;
a response value calculating subunit configured for computing response values of respective points of interest; and
a non-maximum suppression subunit configured for performing non-maximum suppression to the points of interest based on the response values.

8. The apparatus for real-time virtual viewpoint synthesis according to claim 5, wherein the disparity extracting unit performs extracting of the sparse disparity data based on GPU parallel computing; and/or the synthesizing unit performs synthesizing of the images of the virtue viewpoints based on GPU parallel computing.

9. The method for real-time virtual viewpoint synthesis according to claim 2, wherein extracting the sparse disparity data based on the images of left and right-channel real viewpoints are performed using a GPU; and/or synthesizing the image of virtual viewpoints at the corresponding positions is performed using the GPU.

10. The method for real-time virtual viewpoint synthesis according to claim 3, wherein extracting the sparse disparity data based on the images of left and right-channel real viewpoints are performed using a GPU; and/or synthesizing the image of virtual viewpoints at the corresponding positions is performed using the GPU.

11. The apparatus for real-time virtual viewpoint synthesis according to claim 6, wherein the disparity extracting unit performs extracting of the sparse disparity data based on GPU parallel computing; and/or the synthesizing unit performs synthesizing of the images of the virtue viewpoints based on GPU parallel computing.

12. The apparatus for real-time virtual viewpoint synthesis according to claim 7, wherein the disparity extracting unit performs extracting of the sparse disparity data based on GPU parallel computing; and/or the synthesizing unit performs synthesizing of the images of the virtue viewpoints based on GPU parallel computing.
